(19) United States
(12) Patent Application Publication
(10) Pub. No.: US 2011/0163995 A1
(43) Pub. Date: Jul. 7, 2011

(54) TOUCH PANEL AND TOUCH SENSING METHOD

(75) Inventor: Chun-Wei Su, Taipei City (TW)

(73) Assignee: CHUNGHWA PICTURE TUBES, LTD., Taoyuan (TW)

(21) Appl. No.: 12/723,693

(22) Filed: Mar. 15, 2010

(30) Foreign Application Priority Data
Jan. 7, 2010 (TW) 99100236

(51) Int. Cl. G06F 3/042

(52) U.S. Cl. 345/175

(57) ABSTRACT

A touch panel including a plurality of fiber Bragg grating (FBG) columns, a plurality of FBG rows, a wideband light source emitter, a plurality of column sensors, a plurality of row sensors, and two optical couplers is provided. The FBG columns and the FBG rows are interlaced configuration. The wideband light source emitter is connected to the FBG columns and the FBG rows. Each of the column sensors is connected to the corresponding FBG column. Each of the row sensors is connected to the corresponding FBG row. One optical coupler is connected between a first column end of each FBG column and the wideband light source emitter. The other optical coupler is connected between a first row end of each FBG rows and the wideband light source emitter.

### CROSS-REFERENCE TO RELATED APPLICATION

This application claims the priority benefit of Taiwan application serial no. 99100236, filed on Jan. 7, 2010. The entirety of the above-mentioned patent application is hereby incorporated by reference herein and made a part of specification.

### BACKGROUND OF THE INVENTION

1. Field of the Invention

The invention is related to a touch panel and a touch sensing method, and particularly, to a touch panel of high sensitivity and blunt to ambient inferences and a touch sensing method.

2. Description of Related Art

At present, the touch panels can be generally classified into capacitive, resistive, infrared, and ultrasonic touch panels, wherein the resistive touch panels and the capacitive touch panels are most common. The capacitive touch panels have a multi-touch function, which allows a more user-friendly operation mode. Therefore, the capacitive touch panels are gradually favored by the market. Nevertheless, the operation of the capacitive touch panel can only be performed through a conductive material so that the user can not operate the touch panel when wearing the gloves or using a non-conductive material.

Because any material can be used to perform the operation of the touch panel, it is much convenient to use the resistive touch panel. In addition, the cost of the resistive touch panel is low and the technology of the resistive touch panel is mature so that the resistive touch panel has higher market share.

However, electrode patterns with large area are served as the sensing device in the resistive touch panel and the capacitive touch panel, and thus the manufacturing process of the resistive touch panel and the capacitive touch panel applied in large sized products are not easy. In addition, the sensing signal of the resistive touch panel or the capacitive touch panel requires complex treating process, such as amplifying the sensing signal or eliminating the noise, to accurately locate the touching point. Therefore, the technology of the touch panel is needed to be improved.

### SUMMARY OF THE INVENTION

The invention is directed to a touch panel having high sensitivity, easy manufacturing process, and low power consumption.

The invention is directed to a touch sensing method to simplify the treating process of the touch signal to enhance the response speed of the touch sensing operation.

The invention provides a touch panel including a plurality of fiber Bragg grating (FBG) columns, a plurality of FBG rows, a wideband light source emitter, a plurality of column sensors, a plurality of row sensors, and two optical couplers. The FBG rows are interlaced with the FBG columns. The wideband light source emitter is connected to the FBG columns and the FBG rows. Each of the column sensors is connected to an end of one corresponding FBG column. Each of the row sensors is connected to an end of one corresponding FBG row. One optical coupler is connected between each FBG column and the wideband light source emitter, and the other optical coupler is connected between each FBG row and the wideband light source emitter.

In a touch panel according to an embodiment of the invention, the FBG columns and the FBG rows are respectively a plurality of reflective FBGs. Each column sensor is connected to a first column end of one FBG column and each row sensor is connected to a first row end of one FBG row. Meanwhile, one optical coupler is connected between each FBG column and the wideband light source emitter, and the other optical coupler is connected between each FBG row and the wideband light source emitter.

In a touch panel according to an embodiment of the invention, the FBG columns and the FBG rows are respectively a plurality of transmission FBGs. Each column sensor is connected to a first column end of one FBG column and each row sensor is connected to a first row end of one FBG row. Meanwhile, one optical coupler is connected between a second column end of each FBG column and the wideband light source emitter, and the other optical coupler is connected between a second row end of each FBG row and the wideband light source emitter.

In a touch panel according to an embodiment of the invention, the two optical couplers are two linear optical couplers.

According to an embodiment of the invention, the touch panel further includes a control unit connected to the column sensors and the row sensors.

In a touch panel according to an embodiment of the invention, the column sensors and the row sensors are respectively a plurality of optical diodes.

In a touch panel according to an embodiment of the invention, a wideband light source emitted by the wideband light source emitter is an infrared wideband light source.

The invention also provides a touch sensing method applied in the abovementioned touch panel. A first light transmitted by each of the FBG columns is sensed through the corresponding column sensor. It is determined that which one or more of the FBG columns is touched according to a wavelength of the corresponding first light. A second light transmitted by each of the FBG rows is sensed through the corresponding row sensor. It is determined that which one or more of the FBG rows is touched according to a wavelength of the corresponding second light. At least one touch position is determined according to the one or more of the touched FBG columns and the one or more of the touched FBG rows.

In a touch sending method according to an embodiment of the invention, the method for determining which one or more of the FBG columns is touched comprises determining one of the FBG columns is touched when a wavelength of the first light transmitted by the one of the FBG columns is shorter than a wavelength of the first light transmitted by adjacent more of the FBG columns.

In a touch sending method according to an embodiment of the invention, the method for determining which one or more of the FBG rows is touched comprises determining one of the FBG rows is touched when a wavelength of the second light transmitted by the one of the FBG rows is shorter than a wavelength of the second light transmitted by adjacent FBG rows.

In view of the above, the FBGs are served as touch sensing devices in the invention, wherein the FBGs under different magnitudes of deformation can transmit or reflect the light with different wavelengths. Whether the touch panel is touched or not can be direct based on the wavelength of the light transmitted or reflected by the FBGs. Therefore, the touch panel has high sensitivity and simple touch sensing method. In addition, the manufacturing process of the FBGs is easy to facilitate to be applied in large sized products.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B respectively schematically show a reflective FBG and a transmission FBG.

FIG. 2 schematically illustrates a touch panel according to an embodiment of the invention.

FIG. 3 schematically shows a touch sensing method according to an embodiment of the invention.

FIG. 4 schematically illustrates a touch panel according to another embodiment of the invention.

### DESCRIPTION OF EMBODIMENTS

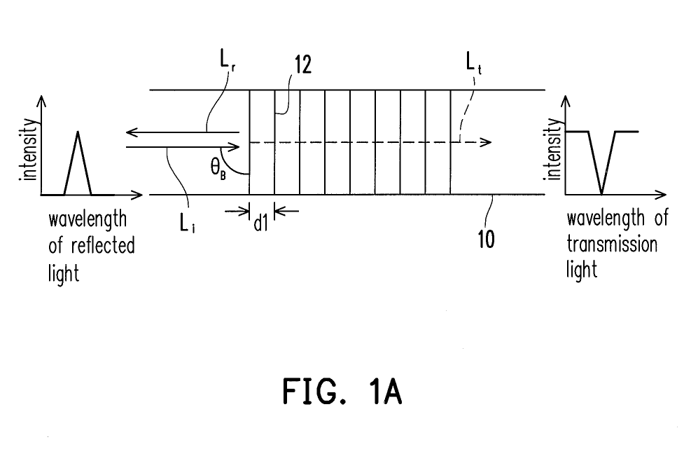

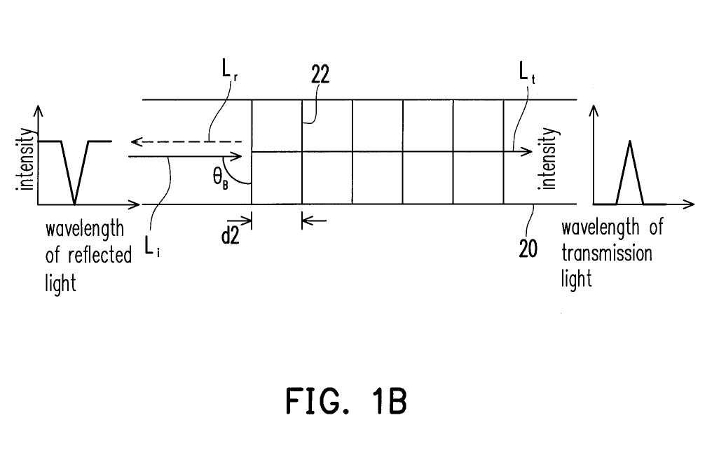

FIG. 1A and FIG. 1B respectively schematically show a reflective FBG and a transmission FBG. Referring to FIGS. 1A and 1B simultaneously, the reflective FBG 10 and the transmission FBG 20 respectively have a grating structure 12 and a grating structure 22. The grating structure 12 has a periodic pitch d1 and the grating structure 22 has a periodic pitch d2.

When a wideband incident light Li enters the reflective FBG 10 in an incident angle θ_{B}, the wideband incident light Li is separated in to a reflective light Lr and a transmission light Lt by the effect of the grating structure 12. In addition, the relationships of the wavelength to the intensity of the reflective light Lr and the transmission light Lt are shown in FIG. 1A. In the reflective FBG 10, the wavelength of the reflective light Lr complies the Bragg's equation

$$sin {θ}_{B} = \frac{λ}{2 d}$$

That is, in a fixed incident angle θ_{B}, the wavelength of the reflective light Lr is decided by the periodic pitch d1 of the grating structure 12.

Similarly, when the wideband incident light Li enters the transmission FBG 10 in the incident angle θ_{B}, the wideband incident light Li is separated in to the reflective light Lr and the transmission light Lt by the effect of the grating structure 22, wherein the wavelength of the transmission light Lt is decided based on the periodic pitch d2 of the grating structure 22. Namely, the relationships of the wavelength to the intensity of the reflective light Lr and the transmission light Lt are shown in FIG. 1B.

While the reflective FBG 10 or the transmission FBG 20 is pressed, the pressed portion thereof is deformed by the pressing pressure so that the refraction index of the reflective FBG 10 or the transmission FBG 20 is changed. Under this circumstance, the reflective light Lr of the reflective FBG 10 and the transmission light Lt of the transmission FBG 20 would have reduced wavelength. Accordingly, the wavelength of the reflective light Lr and the wavelength of the transmission light Lt directly relate to the circumstance whether the reflective FBG 10 and the transmission FBG 20 are pressed or not, and even relate to the intensity of the pressing pressure. The mechanism of changeable refraction index is not influenced and interfered by the ambient conditions and the FBGs are independent from each other. Therefore, the FBGs are used as the touch sensing device of the touch panel in the invention for facilitating better sensitivity, easier manufacturing process, and simpler signal treating process.

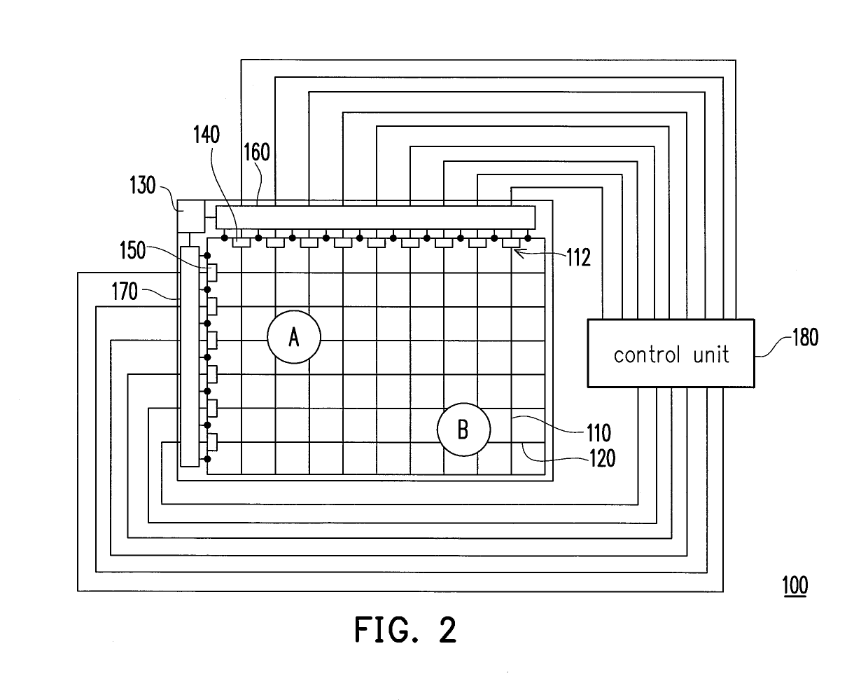

FIG. 2 schematically illustrates a touch panel according to an embodiment of the invention. Referring to FIG. 2, a touch panel 100 includes a plurality of FBG columns 110, a plurality of FBG rows 120, a wideband light source emitter 130, a plurality of column sensors 140, a plurality of row sensors 150, a first optical coupler 160, and a second optical coupler 170. The FBG columns 110 are disposed interlacing to the FBG rows 120. The wideband light source emitter 130 is connected to a first column end 112 of each FBG column 110 through the first optical coupler 160 and connected to a first row end 122 of each FBG row 120 through the second optical coupler 170. Each of the column sensors 140 is connected to one corresponding FBG column 110. Each of the row sensors 150 is connected to one corresponding FBG row 120.

Specifically, the FBG columns 110 and the FBG rows 120 are respectively a plurality of reflective FBGs 10 as shown in FIG. 1A. That is to say, the wavelength of the reflective light reflected by the FBG columns 110 and the FBG rows 120 directly relates to the circumstances whether the FBG columns 110 and the FBG rows 120 are pressed and how much the intensity of the pressing pressure is. In addition, the column sensors 140 and the row sensors 150 are a plurality of optical diodes, for example. A wideband light source emitted by the wideband light source emitter 130 can be an infrared wideband light source. In an embodiment, the wavelength of the infrared wideband light source ranges from 700 μm to 5000 μm.

Alternatively, the FBG columns 110 and the FBG rows 120 are reflective type FBGs, so that the wideband light source emitter 130 of the present embodiment is connected to the first column end 112 of each FBG column through the first optical coupler 160 and connected to the first row end 122 of each FBG row 120 through the second optical coupler 170. Namely, the design of the present embodiment is accomplished by disposing the light emitting device and the light receiving device at the same end (either the ends 112 or the ends 122) of the FBG.

The first optical coupler 160 and the second optical coupler 170 can be respectively be a two-to-one linear optical coupler. In addition, the touch panel 100 further includes a control unit 180 connected to the column sensors 140 and the row sensors 150 for locating the touching point.

In a real structure, the FBG columns 110 and the FBG rows 120 can be disposed on the same substrate (not marked) which can be a flexible substrate or a rigid substrate, but the invention is not restricted thereto. In another embodiment, the FBG columns 110 and the FBG rows 120 can be disposed on the substrate of a display panel. The control unit 180 can be disposed on the substrate disposing with the FBG columns 110 and the FBG rows 120 to form the structure of chip on glass (COG). Nevertheless, the control unit 180 can be individually disposed on a circuit board connected to the substrate with the FBG columns 110 and the FBG rows 120.

It is noted that the capacitive touch panel or the resistive touch panel with a large size requires complex manufacturing process for completely forming the electrode patterns on a substrate. However, the FBG columns 110 and the FBG rows 120 are devices having linear structure themselves. When the touch panel 100 is enlarged, merely the length of the FBG is increased can the large size requirement be achieved. Comparatively, it is easier to fabricate the touch panel 100 with large size.

On the other hand, the optical property of the FBG is not influenced by the ambient temperature, the humidity, or the particles. Therefore, the touch panel 100 has desirable sensitivity. Furthermore, the line width of the FBG is small so that the vision of the display panel is not negatively influenced if the touch panel 100 is combined with or disposed above the display panel. It is also noted that no additional power is required to drive the FBG so as to save the power.

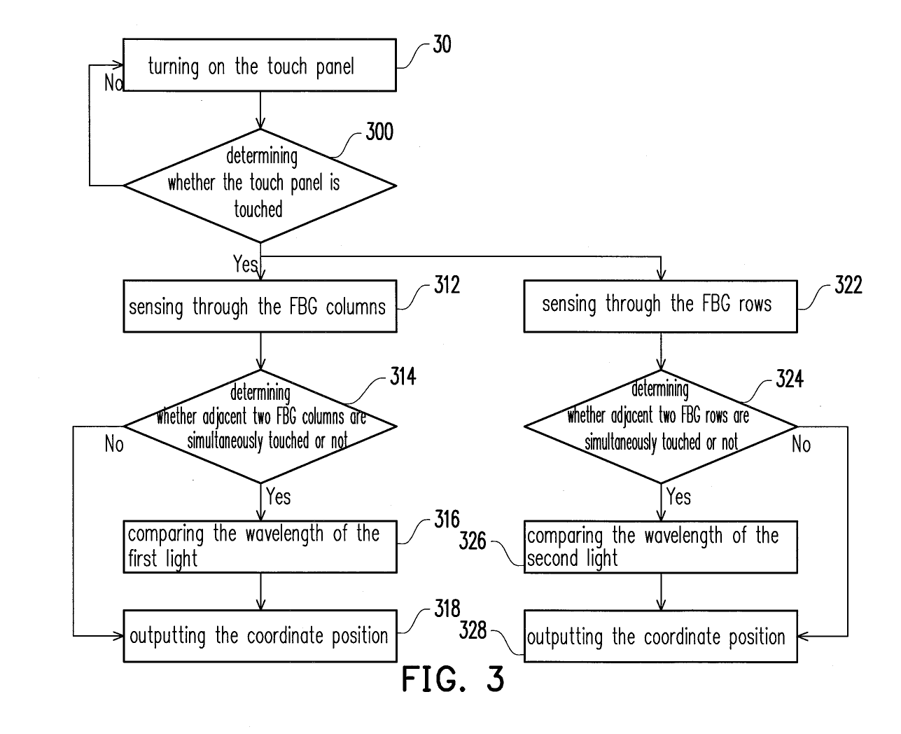

Specifically, the touch sensing method of the touch panel 100 is shown in FIG. 3. Referring to FIGS. 2 and 3 simultaneously, right after the touch panel 100 is turned on (step 30), a step 300 of determining whether the touch panel 100 is touched is performed. If the touch panel 100 is not touched, the step 300 is duplicated. If the touch panel 100 is touched, the step 312 of sensing a first light transmitted by each of the FBG columns 110 through the corresponding column sensor 140 is performed. A wavelength of the received first light is used to determine which one or more of the FBG columns 110 is touched. Simultaneously, the step 322 of sensing a second light transmitted by each of the FBG rows 120 through the corresponding row sensor 150 is also performed.

Two adjacent FBG columns 110 can be simultaneously pressed when a user touches the touch panel 100 through one finger or one object. Therefore, two coordinate positions may be determined when the user only presses a single point so that the problem of signal distortion is generated. Accordingly, the subsequent step 314 of determining whether two adjacent FBG columns 110 are simultaneously touched is performed. If no result shows that two adjacent FBG columns 110 are simultaneously touched, the step 316 is skipped and the step 318 of outputting one corresponding coordinate position is directly performed. If there are two adjacent FBG columns 110 simultaneously touched, the step 316 of comparing the wavelength of the received first light is performed to define an accurate touching point.

Generally, when two adjacent FBG columns 110 are simultaneously touched, the one suffering larger pressure is deemed as the preferred one which the user predetermines to touch. According to the property of the FBG, the first light with shorter wavelength is generated when the FBG suffers higher pressure. Therefore, after the step 316, the FBG column 110 generated the first light with shorter wavelength is served as the reference used in the step 318 for outputting the coordinate point.

The abovementioned steps are applied to define the coordinate position of the touching point in one direction, i.e. the row direction. The method to define the coordinate position of the touching point in the other direction, i.e. the column direction, is to perform the aforesaid steps on the FBG rows 120 and the row sensors 150. That is to say, the steps 322, 324, 326, and 328 are similar to the steps 312, 314, 316, and 318, but are performed on different objects. After the coordinate positions in the two directions are determined, the touching point is accurately obtained for executing the function or the command the user wants to execute.

It is noted that each FBG is independent from others and independent from the influence of the ambient temperature or the humidity so that the signal obtained by performing the above touch sensing method is not required to be amplified and the treatment of eliminating noise is not needed. Hence, the signal treating process and the position calculations of the present embodiment are simple to conduce to enhance the response speed of the touch panel 100. No additional power is required to drive the FBGs so as to reduce the power consumption of the touch panel 100.

In addition, the touch panel 100 also has a multi touch function. As shown in FIG. 2, if the user presses point A and point B simultaneously, the corresponding FBGs can individually reflect the light with shorter wavelength relative to the light reflected by other untouched FBGs. Moreover, the reflected light is individually transmitted in one corresponding FBG. Therefore, the signals received by the sensors 140 or 150 are not interfered with each other so as to facilitate the determination of the coordinate positions of point A and point B and achieve the multi-touch function.

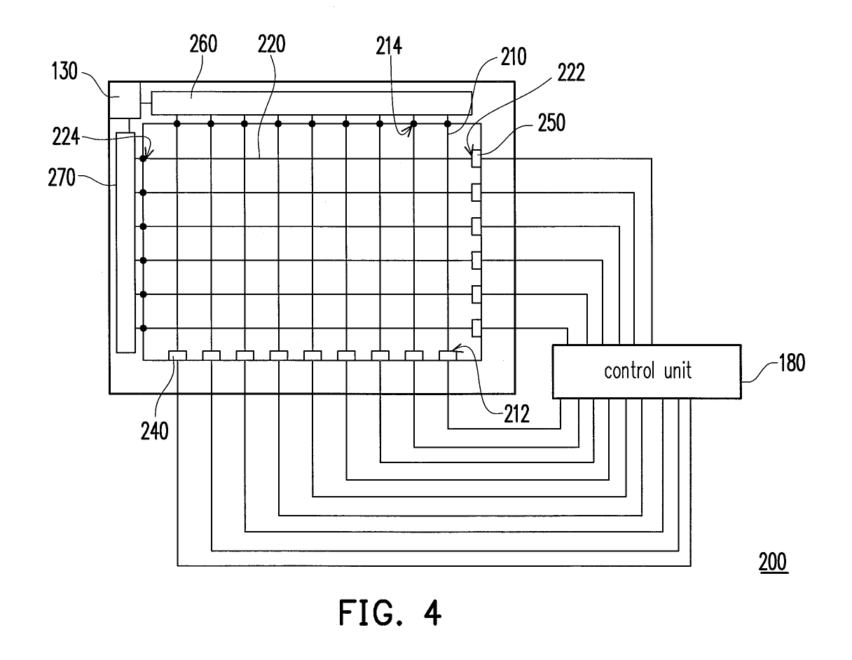

FIG. 4 schematically illustrates a touch panel according to another embodiment of the invention. Referring to FIG. 4, a touch panel 200 includes a plurality of FBG columns 210, a plurality of FBG rows 220, a wideband light source emitter 130, a plurality of column sensors 240, a plurality of row sensors 250, a first optical coupler 260, and a second optical coupler 270. The FBG columns 210 are interlaced with the FBG rows 220. The wideband light source emitter 130 is connected to the FBG columns 210 and the FBG rows 220. Each of the column sensors 240 is connected to one corresponding FBG column 210. Each of the row sensors 250 is connected to one corresponding FBG row 220. Specifically, the wideband light source emitter 130 is connected to each FBG column 210 through the first optical coupler 260 and connected to each FBG row 220 through the second optical coupler 270.

It is noted that the transmission FBG 20 as shown in FIG. 1B is used in the present embodiment to be served as the sensing device, i.e. the FBG columns 210 and the FBG rows 220. Accordingly, each column sensor 240 is connected to a first column end 212 of one FBG column 210 and each row sensor 250 is connected to a first row end 222 of one FBG row 220. Meanwhile, the wideband light source emitter 130 is connected to a second column end 214 of each FBG column 210 through the first optical coupler 260 and connected to a second row end 224 of each FBG row 220 through the second optical coupler 222. In the present embodiment, the first optical coupler 260 and the second optical coupler 170 are, for example, linear optical couplers and the first optical coupler 260 and the second optical coupler 170 are used to merely introduce the light source into each of the FBGs 210 and 220 without having the two-to-one design.

The major difference between the touch panel 100 and the touch panel 200 lies in the types of the FBGs, wherein one is the reflective type and the other is the transmission type. Accordingly, the structures of the two embodiments is varied in the disposition location of the sensors and the layout of the transmission lines. The touch sensing method of the touch panel 200 can be referred to the touch sensing method depicted in the above embodiment. Namely, the steps disclosed in FIG. 3 can be applied in the touch panel 200 to perform the touch sensing method. In other words, the touch panel 200 also has the characteristics of high sensitivity, simple manufacturing process, low power consumption, and multi-touch function.

In summary, the touch sensing function of the invention is achieved by the property of the FBGs which reflect or transmit the light with different wavelengths under different magnitudes of deformation. The sensing signal of the touch panel is blunt to the ambient conditions so as to have desirable sensitivity. In addition, the large sized FBGs are easily fabricated in products so that the size of the touch panel can be enlarged according to different requirements. The line width of the FBGs is small and no additional driving power is required, which is conducive to enhance the quality of the touch panel.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch panel, comprising:
a plurality of fiber Bragg grating (FBG) columns;
a plurality of FBG rows interlaced with the FBG columns;
a wideband light source emitter connected to the FBG columns and the FBG rows;
a plurality of column sensors, each column sensor being connected to the corresponding FBG column;
a plurality of row sensors, each row sensor being connected to the corresponding FBG row; and
two optical couplers, one optical coupler being connected between each FBG column and the wideband light source emitter, and the other optical coupler being connected between each FBG row and the wideband light source emitter.

2. The touch panel according to claim 1, wherein the FBG columns and the FBG rows are respectively a plurality of reflective FBGs.

3. The touch panel according to claim 2, wherein each column sensor is connected to a first column end of one FBG column and each row sensor is connected to a first row end of one FBG row.

4. The touch panel according to claim 3, wherein one of the two optical couplers is connected between the first column end of each FBG column and the wideband light source emitter, and the other optical coupler is connected between the first row end of each FBG row and the wideband light source emitter.

5. The touch panel according to claim 1, wherein the FBG columns and the FBG rows are respectively a plurality of transmission FBGs.

6. The touch panel according to claim 5, wherein each column sensor is connected to a first column end of each FBG column and each row sensor is connected to a first row end of each FBG row.

7. The touch panel according to claim 6, wherein one of the two optical couplers is connected between a second column end of each FBG column and the wideband light source emitter, and the other optical coupler is connected between a second row end of each FBG row and the wideband light source emitter.

8. The touch panel according to claim 1, wherein the two optical couplers are two linear optical couplers.

9. The touch panel according to claim 1, further comprising a control unit connected to the column sensors and the row sensors.

10. The touch panel according to claim 1, wherein the column sensors and the row sensors are respectively a plurality of optical diodes.

11. The touch panel according to claim 1, wherein a wideband light source emitted by the wideband light source emitter is an infrared wideband light source.

12. A touch sensing method applied in the touch panel as claimed in claim 1, comprising:
sensing a first light transmitted by each of the FBG columns through corresponding column sensor;
determining which one or more of the FBG columns is touched according to a wavelength of the corresponding first light;
sensing a second light transmitted by each of the FBG rows through one corresponding row sensor;
determining which one or more of the FBG rows is touched according to a wavelength of the corresponding second light; and
determining at least one touch position according to the one or more of the touched FBG columns and the one or more of the touched FBG rows.

13. The touch sensing method according to claim 12, wherein the method for determining which one or more of the FBG columns is touched comprises determining one of the FBG columns is touched when a wavelength of the first light transmitted by the one of the FBG columns is shorter than a wavelength of the first light transmitted by adjacent more of the FBG columns.

14. The touch sensing method according to claim 12, wherein the method for determining which one or more of the FBG rows is touched comprises determining one of the FBG rows is touched when a wavelength of the second light transmitted by the one of the FBG rows is shorter than a wavelength of the second light transmitted by adjacent more of the FBG rows.
